(19) United States
(12) Patent Application Publication
(10) Pub. No.: US 2015/0143967 A1
(43) Pub. Date: May 28, 2015

(54) SYSTEM, CUTTER ASSEMBLY, AND METHOD FOR AUTOMATIC CHIP BREAKING AND CUTTING MACHINE SYSTEM

(71) Applicant: INSTITUTE FOR INFORMATION INDUSTRY, Taipei City (TW)

(72) Inventors: CHIH CHIEH LIN, TAIPEI CITY (TW); CHUN TAI YEN, TAIPEI CITY (TW); CHIH CHIANG KAO, TAOYUAN COUNTY (TW); HUNG AN KAO, TAIPEI CITY (TW)

(73) Assignee: INSTITUTE FOR INFORMATION INDUSTRY, Taipei City (TW)

(21) Appl. No.: 14/287,177

(22) Filed: May 26, 2014

(30) Foreign Application Priority Data
Nov. 27, 2013 (TW) 102143282

(51) Int. Cl. B23B 25/02

(52) U.S. Cl. CPC B23B 25/02; B23B 2270/30
USPC 82/1.11; 82/118

(57) ABSTRACT

A system for automatic chip breaking used in a cutting machine is illustrated, wherein the cutting machine has a cutter and a spindle actuator. According to control information, the spindle actuator controls the cutter to move along with a first axis to cut a workpiece, and the chips are produced. The system for automatic chip breaking includes a signal collection device, a controller, and an actuator. The signal collection device electrically coupled to the cutting machine collects the control information. The controller electrically coupled to the signal capturing device triggers a control signal according to the control information. The actuator installed between the spindle actuator and the cutter is electrically coupled to the controller, and controls the cutter to vibrate along with a second axis according to the control signal, wherein the second axis and the first axis have a specific angle.

### BACKGROUND

1. Technical Field

The present disclosure relates to a technology for automatic chip breaking which is adapted to a cutting machine, in particular to a system, cutter assembly, and method for automatic chip breaking, and a cutting machine system.

2. Description of Related Art

In the mechanical working field, the object for cutting for the workpiece is mainly achieved through the hardness difference between the cutter and the workpiece. However, when a turning or mechanical cutting process is performed on the workpiece by the cutter, continuous machining chips (i.e. long breaking chips) are usually produced because the cutter usually continuously cuts the workpiece for a long period. The longer the lengths of the machining chips are, the easier the machining chips entangle with the cutter and/or the workpiece (i.e. entangled chips are produced). It causes that the cutter cuts hard when the mechanical cutting process is proceeding; or alternatively, the entangled chips will sabotage the work piece or the machined tool, and cause a safety problem to the operator (machine tool user). Also, it will create more post processing and cleanup operations. Therefore, when the entangled chips are produced, the operator must stop the cutting machine, check the cutting machine, and remove the machining chips which are entangled with the cutter or the workpiece, such that efficiency for cutting is affected. When the machining chips entangle with the cutter and/or the workpiece, the mechanical cutting danger may be even caused.

To solve the problems mentioned above, several manners for breaking the chips are provided in the current market. For example, currently, the cutting machine manufacturer adapts a water-spraying device near the cutter. During the mechanical cutting procedure, the water-spraying device flushes the machining chips to be away from the workpiece or the cutter, so as to achieve the effect of chips breaking. However, in the above manner, an extra water-spraying device must be installed, and thus the maintenance of the cutting machine is increased. Furthermore, the pressure generated by the spraying water may be too large to damage the workpiece. On the other hand, to decrease the possibility that the machining chips entangle with the cutter and/or the workpiece, a chips groove is set on the cutting machine to accommodate the machining chips by some cutting machine manufacturer or research institution. In other case the material of the cutter is refined to prevent the machining chips from falling straight apart from the cutter. However, the manner for setting the chip groove or refining the material of the cutter can merely decrease the producing probability of the entangled chips, and the effect is limited, i.e. the machining chips may still entangle with the cutter and/or the workpiece. Thus, the operator still needs to stop the cutting machine periodically to manually remove the machining chips. If the machining chips are not removed, it is dangerous for the operator, and the cutter and the workpiece may be damaged. Since mechanical cutting operator must periodically stop and check the cutting machine to manually remove the machining chips, it is not convenient for the user, and the mechanical cutting efficiency is decreased.

### SUMMARY

An exemplary embodiment of the present disclosure provides a system for automatic chip breaking, and the system for automatic chip breaking can be used in a cutting machine, wherein the cutting machine comprises a first cutter and a spindle actuator. According to control information, the spindle actuator controls the first cutter to move along with a first axis to cut a workpiece, and the chips are produced. The system for automatically cutting the chips comprises a signal collection device, a controller, and a first actuator. The signal collection device is electrically coupled to the cutting machine, and used to collect the control information. The controller is electrically coupled to the signal capturing device, and used to trigger a control signal according to the control information. The first actuator electrically coupled to the controller is installed between the spindle actuator and the first cutter, and used to control the first cutter to vibrate along with a second axis according to the control signal, wherein the first axis and the second axis have a specific angle.

An exemplary embodiment of the present disclosure provides a cutter assembly for automatic chip breaking, and the cutter assembly is installed on a spindle actuator of a cutting machine. The cutter assembly comprises a first cutter and a first actuator. According to the control information, the spindle actuator controls the first cutter to move along with a first axis to cut a workpiece, and the chips are produced. The first actuator installed between the spindle actuator and the first cutter is controlled by a control signal, so as to control the first cutter to vibrate along with a second axis, wherein the first axis and the second axis have a specific angle, and the control signal is triggered according to the control information of the cutting machine.

An exemplary embodiment of the present disclosure provides a cutting machine system, and the cutting machine system comprises a cutting machine, a signal collection device, a controller, and a first actuator. The cutting machine comprises a first cutter and a spindle actuator, wherein according to control information, the spindle actuator controls the first cutter to move along with a first axis to cut a workpiece, and the chips are produced. The signal collection device is electrically coupled to the cutting machine, and used to collect the control information. The controller is electrically coupled to the signal capturing device, and used to trigger a control signal according to the control information. The first actuator is installed between the spindle actuator and the first cutter, and electrically coupled to the controller. According to the control signal, the first actuator is used to control the first cutter to vibrate along with a second axis, wherein the first axis and the second axis have a specific angle.

An exemplary embodiment of the present disclosure provides a method for automatic chip breaking, and the method for automatic chip breaking is used in a cutting machine, wherein the cutting machine comprises a first cutter and a spindle actuator, the spindle actuator controls the first cutter to move along with a first axis to cut a workpiece according to control information, and the chips are produced. The method for automatic chip breaking comprises the following steps. First, control information is collected by using a signal collection device electrically coupled to the cutting machine. Then, according to the control information, a control signal is triggered by using a controller electrically coupled to the signal capturing device. Furthermore, the first cutter is controlled to vibrate along with a second axis by using a first actuator installed between the spindle actuator and the first cutter and electrically coupled to the controller, wherein the first axis and the second axis have a specific angle.

To sum up, the system, the cutter assembly, and the method for automatic chip breaking and the cutting machine system provided in the present disclosure control the cutter to vibrate according to the control information of the cutting machine, so as to achieve the effect of automatic chip breaking. In other words, the system, the cutter assembly, and method for automatic chip breaking and the cutting machine system provided in the present disclosure can achieve the effect of automatic chip breaking when a mechanical cutting procedure is performed on a workpiece by the cutter. Additionally, by using the system, the cutter assembly, and method for automatic chip breaking, and the cutting machine system provided in the exemplary embodiments of the present disclosure, the mechanical cutting operator does not need to stop the machining procedure to remove the entangled chips manually, and thus the mechanical cutting activation rate and the yielding rate can be efficiently improved.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of a cutting machine system according to an embodiment of the present disclosure.

FIG. 2 is a flowchart of a method for automatic chip breaking according to an embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

It should be noted that the words “first”, “second”, and “third” are used to describe different elements, and such elements should not be limited by the meanings of these words, or not to mean in an order. Such words are used to mark one element from another. Therefore, the first element might be seen as the second element and it would not depart from the disclosure. Also, the word “or” might include any one or the composition of the listing elements depending on the actual situation.

### Exemplary Embodiment of Cutting Machine

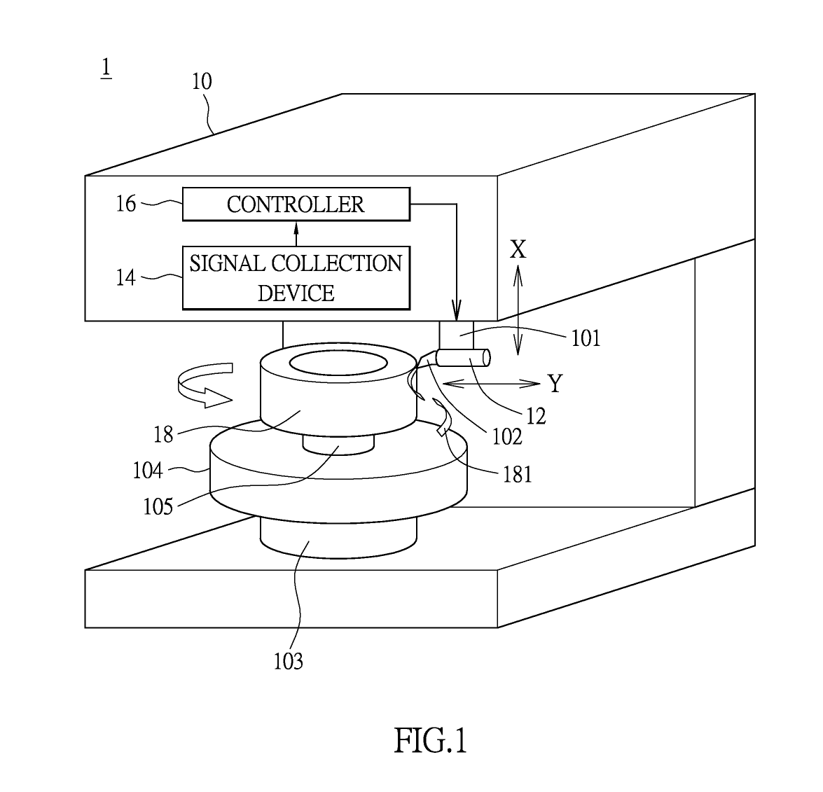

Referring to FIG. 1, FIG. 1 is a schematic diagram of a cutting machine system according to an embodiment of the present disclosure. The cutting machine system 1 comprises a cutting machine 10, a first actuator 12, a signal collection device 14, and a controller 16. The cutting machine 10 comprises a spindle actuator 101, a first cutter 102, and a servo-actuator 103. In the present exemplary embodiment, the signal collection device 14 is electrically coupled to the cutting machine 10, and the controller 16 is electrically coupled to the signal collection device 14. The first actuator 12 is installed between the spindle actuator 101 and the first cutter 102, and the first actuator 12 is electrically coupled to the controller 16. The controller 16 is electrically coupled to the signal collection device 14. A workbench 104 is disposed between the servo-actuator 103 and a jig 105, and a workpiece 18 is fixed to the jig 105, such that the workpiece 18 is worked on the workbench 104.

The signal collection device 14 collects control information. The control information comprises main spindle information, servo motor information, numeric control (NC) program, or cutter-compensation parameters. For example, the main spindle information may be a turning speed of the spindle actuator 101, the servo motor information may be the location information of the workpiece 18 to the servo-actuator 103, the cutter-compensation parameters may be an offset or a deviation for the first cutter 102, and the NC program may be path information for the first cutter 102.

In practice, the main spindle information, the servo motor information, the NC program, or the cutter-compensation parameters may be inputted through an operation interface of a computer device of the cutting machine 10 by a user according to an actual demand. The main spindle information, the servo motor information, the NC program, or the cutter-compensation parameters also may be related data pre-stored in the computer device of the cutting machine 10. The main spindle information or the servo motor information can be sensed by the marketed sensor, and for example can be generated by sensing the location turning speed or the rotating speed. In short, the present disclosure does not intend to limit the types of the control information and the means for acquiring the control information.

The controller 16 is used to trigger a control signal according to the control information. In the exemplary embodiment, the controller 16 may be a programmable chip or an electronic component having hardware based logic circuits. However, the present disclosure does not intend to limit the types of the controller 16 and the means for implementing the controller 16.

It should be noticed that the signal collection device 14 and the controller 16 may be combined to an embedded device (p.s. the embedded device is not shown in drawings, and can be an embedded system, such as an industry computer, a set-top box, and a programmable logic controller (PLC), and so on). The embedded device can be installed in the cutting machine 10, or be set near the cutting machine 10 as an independent device. However, in other exemplary embodiment, the person with ordinary skill in the art may perform different design for the signal collection device 14 and the controller 16 according to the practical situation, and the present disclosure is not limited thereto. For example, the signal collection device 14 and the controller 16 may be one part of the cutting machine 10, or one part of the PLC of the cutting machine 10. On the other hand, without changing the original architecture of the cutting machine 10, the signal collection device 14 and the controller 16 are combined to the embedded device, and installed near the cutting machine 10 to electrically connect with the cutting machine 10.

According to the control information, the spindle actuator 101 controls the first cutter 102 to move along with a first axis X (for example, a main spindle axis, but the present disclosure is not limited thereto) to cut the workpiece 18. When the cutter cuts the workpiece 18, the chips 181 may be produced, and entangle with the first cutter 102. For example, according to at least one batch of the main spindle information, the servo motor information, the NC program, and the cutter-compensation parameters, the spindle actuator 101 may control a turning speed or a movement which the first cutter 102 moves along with the first axis X, such that the first cutter 102 cuts the workpiece 18 fixed on the servo-actuator 103. Because the first cutter 102 cuts the workpiece 181 continuously, the chips 181 may be produced and entangled with the first cutter 102. In the exemplary embodiment, the first axis X is the direction that the spindle actuator 101 moves upward or downward. However, the present disclosure does not intend to limit the direction of the first axis X, and the person with ordinary skill in the art may design the direction of the first axis X according to the actual situation.

The first actuator 12 controls the first cutter 102 to vibrate along with a second axis Y (for example, a vibration axis, but the present disclosure is not limited thereto) according to the control signal triggered by the controller 16. Under the circumstances that the cutting accuracy of the workpiece 181 cannot be affected, the first cutter 102 may vibrate fast and slightly in the machining procedure, therefore, the first cutter 102 does not contact the workpiece 18 continuously, and the lengths of the machining chips may not too long to produce the entangled chips. Hence, the chips 181 may fall off automatically, and the effect of automatic chip breaking is achieved. More particularly, according to the control information, the controller 16 calculates a vibration frequency which the first cutter 102 vibrates along with the second axis Y, and correspondingly triggers the control signal to the first actuator 12 for controlling the first cutter 102 to vibrate along with the second axis Y at a specific frequency. Therefore, the lengths of the chips 181 remain within a specific range, and the effect of automatic chip breaking is achieved. In a preferred exemplary embodiment, the second axis Y is the direction that the first actuator 12 moves leftward or rightward. The specific angle between the first axis X and the second axis Y may be 90 degree. However, the present disclosure does not intend to limit the direction of the first axis X, the direction of the second axis Y, and the specific angle between the first axis X and the second axis Y. That is, the second axis may be a Z axis, any axis belongs to a Y-Z plane. Moreover, the second axis may be not perpendicular to the first axis X; for example, the first axis and the second axis may have the specific angle of 85 degree, 80 degree, or other degree.

For example, in the machining procedure, after the signal collection device 14 determines the characteristics (such as a size or a scale) of the workpiece 18 to be cut according to the collected control information (such as at least one batch of the main spindle information, the servo motor information, the NC program, and the cutter-compensation parameters), the signal collection device 14 outputs a vibration frequency information to the controller 16 according to the determined result. When the controller 16 receives the vibration frequency information, according to the vibration frequency, the controller 16 triggers the control signal to the first actuator 12. When the first actuator 12 receives the control signal, the first actuator 12 controls the first cutter 102 to contact the workpiece 18 continuously at a fixed vibration frequency. Therefore, the chips 181 can fall off automatically.

It should be noticed that the vibration frequency information may be embedded into the machining procedure program by inserting a Macro instruction or a program segment. Hence, when the controller 16 reads the vibration frequency information of the machining procedure program, the controller 16 outputs the control signal to control the first actuator 12, and thus the first actuator 12 controls the first cutter 102 to vibrate at the fixed vibration frequency for breaking the chips 181.

In addition, though the controller 16 may control the first actuator 12 to control the first cutter 102 to vibrate at the fixed vibration frequency to break the chips 181 by using the above manner, the controller 16 may also determine the vibration frequency according to the control information by using another manner. For example, the controller 16 can input the content of the control information into a specific formula to calculate the vibration frequency; or alternatively, the controller 16 may determine the vibration frequency according to the control information via the optimum or sub-optimum solving algorithm (such as the genetic algorithm or the fuzzy control algorithm). In short, the present disclosure does not intend to limit the means for acquiring the vibration frequency for the first cutter 102 according to the control information. The person with ordinary skill in the art may design the means for obtaining the vibration frequency of the first cutter 102 according to the actual situation.

In the other exemplary embodiment, the first actuator 12, the signal capturing device 14, and the controller 16 may form a system for automatic chip breaking. The system for automatic chip breaking can be linked to the cutting machine 10 to control the first cutter 102 to vibrate along with the second axis Y. That is, in the present exemplary embodiment, according to the control information, the spindle actuator 101 controls the first cutter 102 to move along with a first axis X to cut a workpiece 18. Meanwhile, the system for automatic chip breaking may also acquire the vibration frequency according to the control information, and the control signal corresponding to the vibration frequency can be transmitted to the first actuator 12, such that the first actuator 12 controls the first cutter 102 to vibrate along with the second axis Y with the specific frequency according to the control signal.

In brief, when the spindle actuator 101 controls the first cutter 102 to move along with the first axis X according to the control information, and thus the workpiece 18 is cut, the produced chips 181 may entangle with the first cutter 102. Meanwhile, the system for automatic chip breaking (not shown in drawings) can control the first cutter 102 to vibrate along with the second axis Y at the specific vibration frequency according to the control information, such that the chips 181 may fall off and break automatically. Therefore, the mechanical cutting efficiency can be increased. Moreover, the system for automatic chip breaking may be embedded into, installed in or mounted on any cutting machine 10 which produces chips 181, even the system for automatic chip breaking can be implemented in the cutting machine 10 (i.e. the system for automatic chip breaking can be one part of the cutting machine). In short, the present disclosure does not intend to limit the configuration, combination, or implementation of the system for automatic chip breaking, and the person with ordinary skill in the art can design the configuration, combination, or implementation of the system according to the actual situation.

In another exemplary embodiment, the first cutter 102 and the first actuator 12 can form the cutter assembly for automatic chip breaking. In the exemplary embodiment, the cutter assembly for automatic chip breaking may be mounted on the cutting machine 10, such that the first cutter 102 can move along with the first axis X and the second axis Y. Therefore, when the spindle actuator 101 controls the first cutter 102 to cut the workpiece 18, and the chips 181 are produced, the first actuator 12 can control the first cutter 102 to vibrate along with the second axis Y at the vibration frequency. Therefore, the chips 181 may fall off and break automatically, but does not entangle with the first cutter 102, and the mechanical cutting efficiency can be increased. On the other hand, the cutter assembly for automatic chip breaking can be installed in any cutting machine which produces the chips 181.

In the present exemplary embodiment, the first cutter 102 may be, for example, a drilling machining cutter, a gear machining cutter, or a breaking machining cutter. However, the present disclosure does not intend to limit the type, the material, and the size of the first cutter 102, and the person with ordinary skill in the art can design the first cutter 102 according to the actual situation. In the exemplary embodiment, the workpiece 18 may be a metal or non-metal part to be cut. However, the present disclosure does not intend to limit the type, the material, and the size of the workpiece 18. The person with ordinary skill in the art can design the workpiece 18 according to the actual situation. In the exemplary embodiment, the first actuator 12, the spindle actuator 101, and the servo-actuator 103 can be motors, piezoelectric actuators, or any transducers that can convert the electrical energy to the physical energy. However, the present disclosure does not intend to limit the types, the materials, and the sizes of the first actuator 12, the spindle actuator 101, and the servo-actuator 103. The person with ordinary skill in the art can design the first actuator 12, the spindle actuator 101 and the servo-actuator 103 according to the actual situation.

In brief, when the spindle actuator 101 controls the first cutter 102 to move along with a first axis to continuously cut a workpiece 18 according to the control information, the chips 181 may be produced and entangle with the first cutter 102 and/or the workpiece 18. The controller 16 may determine the vibration frequency according to at least one batch of the main spindle information, the servo motor information, the NC program, and the cutter-compensation parameters, and triggers the control signal corresponding to the vibration frequency to the first actuator 12, such that the first actuator 12 can control the first cutter 102 to vibrate according to the vibration frequency along with the second axis Y. Hence, the chips 181 may be removed automatically, the mechanical cutting efficiency of the cutting machine 10 can be increased, and the danger probability of the mechanical cutting procedure can be decreased.

Besides, though the system for automatic chip breaking in the exemplary embodiment merely includes one set of cutter assembly (the first cutter 102 and the first actuator 12) for automatic chip breaking, in another embodiment, the system for automatic chip breaking may include two or more sets of cutter assemblies for automatic chip breaking.

In another exemplary embodiment, the system for automatic chip breakings and/or the cutting machine system comprises a first cutter assembly (the first cutter and the first actuator) for automatic chip breaking and a second cutter assembly (a second cutter and a second actuator) for automatic chip breaking, wherein the second actuator is installed between the spindle actuator and the second cutter, and electrically coupled to the controller. The second actuator replaces the first actuator, and controls the second cutter to vibrate along with the second axis Y according to the control signal. That is, the first cutter assembly and the second cutter assembly are used to replace each other, wherein the second cutter can replace the first cutter, and the second actuator can replace the first actuator, and vice versa. In practice, the cutter assemblies of the system for automatic chip breaking or the cutting machine system can be replaced by a known cutter assembly switching device. Therefore, the system for automatic chip breaking or the cutting machine system can selects the suitable cutter and actuator according to the cutting demand or the cutting program. The first actuator can be a piezoelectric actuator, and the second actuator can be a piezoelectric oil-pressure actuator.

Furthermore, the controller 16 selectively drives the first cutter assembly or the second cutter assembly to automatically break the chips 181 according to the characteristics (such as a weight or a size) of the workpiece 18 or the rotation speed of the servo-actuation 103 in the machining procedure, so as to achieve the chip breaking effect.

It should be noticed that the first actuator is a piezoelectric actuator, and the second actuator is a piezoelectric oil-pressure actuator. The present disclosure does not intend to limit the type of the first actuator or the second actuator, and the person with ordinary skill in the art can design the first actuator and the second actuator according to the actual situation.

By the way, the controller 16 can selectively drive the first cutter assembly or the second cutter assembly to automatically break to chips 181 not only according to the characteristics (such as the weight or the dimension) of the workpiece 18, but also according to the program segment in the cutting procedure program. The present disclosure does not intend to limit the means for selectively driving one of the cutter assemblies, and the person with ordinary skill in the art can design the means for selectively driving one of the cutter assemblies according to the actual situation.

### Exemplary Embodiment of Method for Automatic Chip Breaking

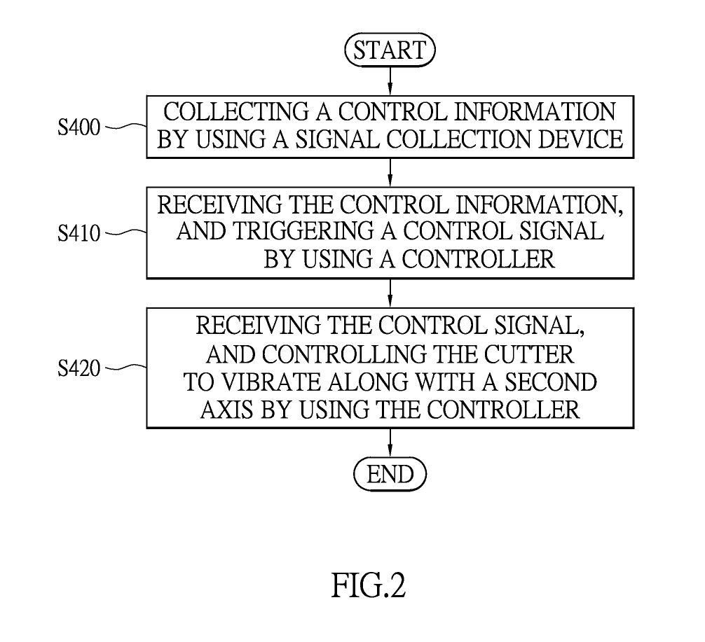

Referring to FIG. 1 and FIG. 2, FIG. 2 is a flowchart of a method for automatic chip breaking according to an exemplary embodiment of the present disclosure. The method for automatic chip breaking can be executed in the system for automatic chip breaking and the cutting machine system 1, but the present disclosure is not limited thereto. Steps of the method for automatic chip breaking are illustrated in the following description.

First, at step S400, the signal collection device 14 collects the control signal. Then, at step S410, the controller 16 receives the control signal to trigger the control signal. Next, at step S420, the first actuator 12 receives the control signal, and controls the first cutter 102 to vibrate along with the second axis Y.

More specifically, at step 400, when the cutting machine starts to cut the workpiece, the signal collection device 14 electrically coupled to the cutting machine 10 collects the control information of the cutting machine 10, wherein the control information comprises at least one batch of the main spindle information, the servo motor information, the NC program, and the cutter-compensation parameters. The main spindle information may be a turning speed of the spindle actuator 101, and the servo motor information may be the location information of the workpiece 18 to the servo-actuator 103, and the cutter-compensation parameters may be an offset or a deviation for the first cutter 102, and the NC program may be the path information for the first cutter 102.

At step S410, the controller electrically coupled to the signal collection device receives the control information collected by the signal collection device, and triggers the control signal. The controller 16 calculates the vibration frequency which the first cutter 102 vibrates along with the second axis Y according to the control information, and triggers the control signal correspondingly. The controller 16 may calculate the vibration frequency which the first cutter vibrates along with the second axis Y by using a lookup table. The lookup table records the respective vibration frequency range, which the first cutter 102 vibrates along with the second axis Y, corresponding to the main spindle information, the servo motor information, the NC program, and the cutter-compensation parameters. On the other hand, the controller 16 may also determine the vibration frequency according the control information by other manner. For example, the controller 16 can input the content of the control information into a specific formula to calculate the vibration frequency; or alternatively, the controller 16 may determine the vibration frequency according to the control information via the optimum or sub-optimum solving algorithm (such as the genetic algorithm or the fuzzy control algorithm).

At step S420, the first actuator 12 installed between the spindle actuator and the first cutter and electrically coupled to the controller receives the control signal transmitted by the controller. Then, the first actuator controls the first cutter 102 according to the control signal to vibrate along with the second axis Y. The control signal contains the vibration frequency information, and therefore, according to the received control signal, the first actuator 12 controls the first cutter 102 to vibrate along with the second axis Y at the specific vibration frequency corresponding to the control signal. Hence, the spindle actuator 101 controls the first cutter 102 to move along with the first axis X, and the chips 181 produced when the workpiece 18 is cut may fall off due to the vibration of the first cutter 102, so as to achieve the effect of automatic chip breaking. Accordingly, the method for automatic chip breaking increases the yielding rate and the mechanical cutting activation rate.

### Possible Effect of Exemplary Embodiment

As described above, the system, the cutter assembly, and the method for automatic chip breaking, and the cutting machine system provided in the exemplary embodiments of the present disclosure control the cutter to vibrate according to the control information of the cutting machine, and the effect of automatic chip breaking is achieved. In other words, the system, the cutter assembly, and the method for an automatic chip breaking, and cutting machine system mentioned above do need the extra chips cutting device (such as a water-spraying device or a chip groove) installed or use the cutter made of specific matter, and the effect of the automatic chip breaking can be achieved when the cutter cuts the workpiece. By using the system, the cutter assembly, and method for an automatic chip breaking, and the cutting machine system provided in the exemplary embodiments of the present disclosure, the mechanical cutting operator does not need to stop the machining procedure periodically to remove the entangled chips manually, and thus the mechanical cutting activation rate and the yielding rate can be efficiently improved. In addition, it is not complicated to implement the system, the cutter assembly, and the method for automatic chip breaking, and the cutting machine system mentioned above, and the expensive cost is saved. Furthermore, the danger probability for the mechanical cutting operator is decreased. In a word, the system, the cutter assembly, and the method for automatic chip breaking, and the cutting machine system provided in exemplary embodiments of the present disclosure can accurately and steadily break the chips, and thus the yielding rate and the mechanical cutting activation rate can be efficiently increased.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A system for automatic chip breaking, used in a cutting machine, wherein the cutting machine includes a first cutter and a spindle actuator, wherein the spindle actuator controls the first cutter according to control information to move along with a first axis to cut a workpiece and the chips are produced, and the system for automatic chip breaking comprises:
a signal collection device, electrically coupled to the cutting machine, collecting the control information;
a controller, electrically coupled to the signal collection device, triggering a control signal according to the control information; and
a first actuator, installed between the spindle actuator and the first cutter and electrically coupled to the controller, controlling the first cutter to vibrate along with a second axis according to the control signal, wherein the first axis and the second axis have a specific angle.

2. The system for automatic chip breaking according to claim 1, wherein the control information comprises at least one batch of main spindle information, servo motor information, NC program, and cutter-compensation parameters.

3. The system for automatic chip breaking according to claim 1, wherein according to the control information, the controller is used to calculate a vibration frequency which the first cutter vibrates along with the second axis, and trigger the control signal to the first actuator correspondingly, so as to control the first cutter to vibrate along with the second axis.

4. The system for automatic chip breaking according to claim 1, further comprising:
a second actuator, electrically coupled to the controller, installed between the spindle actuator and a second cutter, wherein the second actuator and the second cutter are used to replace the first actuator and the second cutter respectively, and the second actuator is used to control the second cutter to vibrate along with the second axis according to the control signal.

5. The system for automatic chip breaking according to claim 4, wherein the first actuator is a piezoelectric actuator, and the second actuator is a piezoelectric oil-pressure actuator.

6. A cutter assembly for automatic chip breaking, installed on a spindle actuator of a cutting machine, comprising:
a first cutter, wherein the spindle actuator controls the first cutter according to a control information to move along with a first axis to cut a workpiece, and the chips are produced; and
a first actuator, installed between the spindle actuator and the first cutter, controlled by a control signal to control the first cutter to vibrate along with a second axis, wherein the first axis and the second axis have a specific angle, and the control signal is triggered according to the control information of the cutting machine.

7. The cutter assembly according to claim 6, wherein the control information comprises at least one batch of main spindle information, servo motor information, NC program, and cutter-compensation parameters.

8. The cutter assembly according to claim 6, further comprising:
a controller, electrically coupled to the cutting machine, calculating a vibration frequency which the first cutter vibrates along with the second axis according to the control information, triggering the control signal to the first actuator correspondingly, so as to control the first cutter to vibrate along with the second axis.

9. The cutter assembly according to claim 8, further comprising:
a second cutter, replacing the first cutter, wherein according to the control information, the spindle actuator controls the second cutter to move along with the first axis; and
a second actuator, installed between the spindle actuator and the second cutter, electrically coupled to the controller, replacing the first actuator, and controlling the second cutter to vibrate along with the second axis according to the control signal.

10. The cutter assembly according to claim 9, wherein the first actuator is a piezoelectric actuator, and the second actuator is a piezoelectric oil-pressure actuator.

11. A cutting machine system, comprising:
a cutting machine, comprising a first cutter and a spindle actuator, wherein to a control information, the spindle actuator controls the first cutter according to move along with a first axis to cut a workpiece, and the chips are produced;
a signal collection device, electrically coupled to the cutting machine, collecting the control information;
a controller, electrically coupled to the signal collection device, triggering a control signal according to the control information; and
a first actuator, installed between the spindle actuator and the first cutter, electrically coupled to the controller, controlling the first cutter to vibrate along with a second axis according to the control signal, wherein the first axis and the second axis have a specific angle.

12. The cutting machine system according to claim 11, wherein the control information comprises at least one batch of main spindle information, a servo motor information, a NC program, and a cutter-compensation parameters.

13. The cutting machine system according to claim 11, wherein according to the control information, the controller is used to calculate a vibration frequency which the first cutter vibrates along with the second axis, and trigger the control signal to the first actuator correspondingly, so as to control the first cutter to vibrate along with the second axis.

14. The cutting machine system according to claim 11, further comprising:
a second cutter, exchanging with the first cutter, wherein according to the control information, the spindle actuator controls the second cutter to move along with the first axis; and
a second actuator, installed between the spindle actuator and the second cutter, electrically coupled to the controller, exchanging with the first actuator, and controlling the second cutter to vibrate along with the second axis according to the control signal.

15. The cutting machine system according to claim 14, wherein the first actuator is a piezoelectric actuator, and the second actuator is a piezoelectric oil-pressure actuator.

16. A method for automatic chip breaking, used in a cutting machine, wherein the cutting machine comprises a first cutter and a spindle actuator, according to a control information, the spindle actuator controls the first cutter to move along with a first axis to cut a workpiece, the chips are produced, and the method for automatic chip breaking comprises:
collecting the control information by using a signal collection device electrically coupled to the cutting machine;
triggering a control signal according to the control information by using a controller electrically coupled to the signal collection device; and
controlling the first cutter to vibrate along with a second axis by using a first actuator installed between the spindle actuator and the first cutter and electrically coupled to the controller, wherein the first axis and the second axis have a specific angle.

17. The method for automatic chip breaking according to claim 16, wherein the control information comprises at least one batch of main spindle information, servo motor information, a NC program, and a cutter-compensation parameters.

18. The method for automatic chip breaking according to claim 16, wherein according to the control information, the controller is used to calculate a vibration frequency which the first cutter vibrates along with the second axis, and trigger the control signal to the first actuator correspondingly, so as to control the first cutter to vibrate along with the second axis.

19. The method for automatic chip breaking according to claim 16, wherein the cutting machine further comprises a second cutter and a second actuator, the second cutter is used to exchange with the first cutter, and according to the control information, the spindle actuator controls the second cutter to move along with the first axis; the second actuator is installed between the spindle actuator and the second cutter, electrically coupled to the controller, and used to replace the first actuator, wherein according to the control signal, the second actuator controls the second cutter to vibrate along with the second axis.

20. The method for automatic chip breaking according to claim 19, wherein the first actuator is a piezoelectric actuator, and the second actuator is a piezoelectric oil-pressure actuator.
